(19) United States
(12) Patent Application Publication
(10) Pub. No.: US 2020/0025554 A1
(43) Pub. Date: Jan. 23, 2020

(54) SYSTEM, METHOD AND COMPUTER PROGRAM PRODUCT FOR FAST AUTOMATIC DETERMINATION OF SIGNALS FOR EFFICIENT METROLOGY

(71) Applicant: KLA-Tencor Corporation, Milpitas, CA (US)

(72) Inventors: Antonio A. Gellineau, Santa Clara, CA (US); Alexander Kuznetsov, Mountain View, CA (US); John J. Hench, Los Gatos, CA (US); Andrei V. Shchegrov, Los Gatos, CA (US); Stilian Ivanov Pandev, Santa Clara, CA (US)

(21) Appl. No.: 15/362,741

(22) Filed: Nov. 28, 2016

Related U.S. Application Data
(60) Provisional application No. 62/264,842, filed on Dec. 8, 2015.

(51) Int. Cl. G01B 11/02

(52) U.S. Cl. CPC G01B 11/02

(57) ABSTRACT

A system, method and computer program product are provided for selecting signals to be measured utilizing a metrology tool that optimizes the precision of the measurement. The technique includes the steps of simulating a set of signals for measuring one or more parameters of a metrology target. A normalized Jacobian matrix corresponding to the set of signals is generated, a subset of signals in the simulated set of signals is selected that optimizes a performance metric associated with measuring the one or more parameters of the metrology target based on the normalized Jacobian matrix, and a metrology tool is utilized to collect a measurement for each signal in the subset of signals for the metrology target. For a given number of signals collected by the metrology tool, this technique optimizes the precision of such measurements over conventional techniques that collect signals uniformly distributed over a range of process parameters.

### RELATED APPLICATION(S)

This application claims the benefit of U.S. Provisional Patent Application No. 61/264,482 filed Dec. 8, 2015, the entire contents of which are incorporated herein by reference.

### FIELD OF THE INVENTION

The present invention relates to metrology tools, and more particularly to configuration of metrology tools.

### BACKGROUND

Metrology generally involves measuring various physical features of a target component. For example, structural and material characteristics (e.g. material composition, dimensional characteristics of structures and/or critical dimensions of structures, etc.) of the target component can be measured using metrology tools. In the example of semiconductor metrology, various physical features of a fabricated semiconductor component may be measured using a metrology tool.

Once a metrology measurement is obtained, the measurement may be analyzed. This analysis typically involves an algorithm that deduces parameter values of a parametric model of the target component, such that a simulation of the measurement associated with those values closely match the actual measurement. Such algorithms typically fall within a class of mathematical problems called “inverse problems”. One such embodiment is a regression that minimizes the normed error between an actual measurement and simulated measurements derived from the parametric model. Often, for the purposes of reducing the total amount of time required to solve an inverse problem, the rigorous simulation of the measurement is replaced by a library, which is a fast and sufficiently accurate mathematical approximation of the simulation for the model parametrization specific to the target component. Typically, a library is computed by an interpolator that is trained on a large set of simulated measurements, the parameters of which fall within the expected range of the parameters for the target component.

In some circumstances, it is desirable to use multiple different metrology tools to measure a target component. This technique is generally known as “hybrid metrology.” There may be many reasons to employ the multiple different metrology tools, such as insufficient measurement performance of individual metrology tools. The expectation then is that two or more metrology tools using different measurement techniques can be combined, with each technique used according to its particular strengths, to produce a total measurement that meets specifications for stability and. process tracking, on all the critical dimensional and composition parameters for the target component. One example of an existing hybrid metrology tool is described in A. Vaid et al., “A Holistic Metrology Approach: Hybrid Metrology Utilizing Scatterometry, CD-AFM, and CD-SEM”, SPIE Proc. Vol, 7971 (2011).

In order to get an accurate measurement of a parameter, many different measurements may be collected using two or more metrology tools. For example, a reflectometer and a spectroscopic ellipsometer may be used to collect a set of signals for measuring one or more parameters. Configuration of these tools may include selection of wavelength, polarization, azimuth, and/or incidence parameters. For example, the spectroscopic ellipsometer may be configured at azimuth angles between 0 and 90 degrees and wavelengths between 100 and 900 nm that range from ultraviolet to infrared. The reflectometer may be configured using polarization angles between vertical and horizontal and wavelengths between 100 and 900 nm that range from ultraviolet to infrared. By taking measurements across the entire spectrum of configurations, the most precise measurement of the target parameters may be obtained. However, this would require thousands of individual measurements, which can be time consuming.

In high throughput manufacturing operations, time constraints may dictate that a subset of measurements may be taken. Conventionally, only a subset of wavelengths is chosen within each tool configuration to reduce the number of individual measurements collected. For example, the reflectometer may be set with horizontal polarization and vertical polarization, and, for each configuration, a number of measurements are taken based on a subset of wavelengths uniformly distributed within the operating band of wavelengths (e.g., the wavelength is incremented by 20 nm between each measurement) Similarly, the spectroscopic ellipsometer may be configured at 0, 45, and 90 degrees of azimuth, and, for each configuration, a number of measurements are taken based on a subset of wavelengths uniformly distributed within the operating band of wavelengths. However, by reducing the number of measurements from the full spectrum, the error of the measured parameter may increase. Furthermore, many of these measurements may not actually yield much useful information. There is thus a need for addressing these and/or other issues associated with the prior art implementations of inspection systems.

### SUMMARY

A system, method and computer program product are provided for selecting signals to be measured utilizing a metrology tool that optimizes the precision of the measurement. The technique includes the steps of simulating a set of signals for measuring one or more parameters of a metrology target. At the heart of this technique is the normalized Jacobian matrix, which essentially is the noise weighted parameteric sensitivity of the measure spectra. Many performance metrics, such as parametric precision, may be computed directly from the normalized Jacobian matrix. Once a normalized Jacobian matrix corresponding to the set of signals is generated, a subset of signals in the simulated set of signals is selected that optimizes a performance metric associated with measuring the one or more parameters of the metrology, and a metrology tool is utilized to collect a measurement for each signal in the subset of signals for the metrology target. For a given number of signals collected by the metrology tool, this technique optimizes the precision of such measurements over conventional techniques that collect signals uniformly distributed over a range of process parameters.

BRIEF DESCRIPTION OF THE DRAWINGS

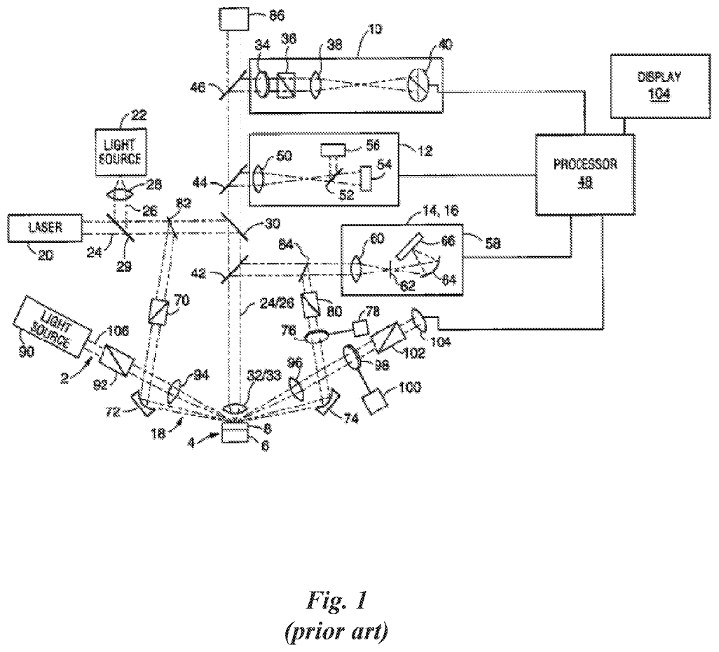

FIG. 1 shows a schematic of an exemplary metrology tool, in accordance with the prior art;

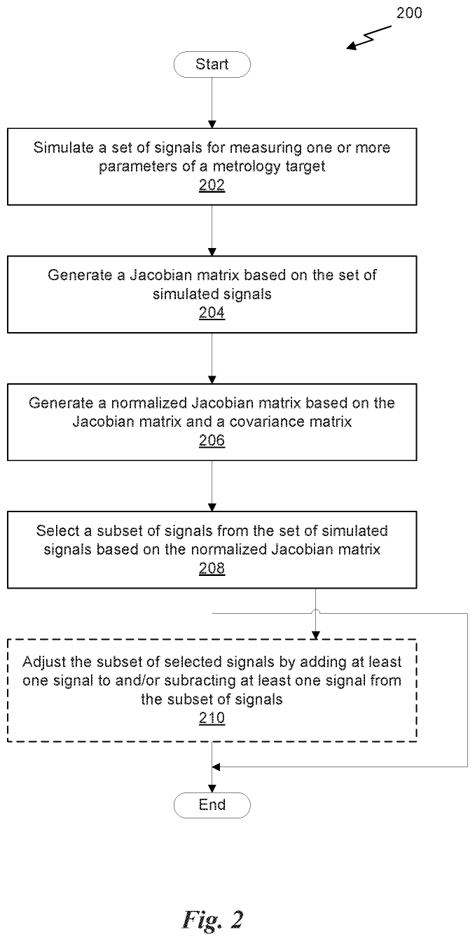

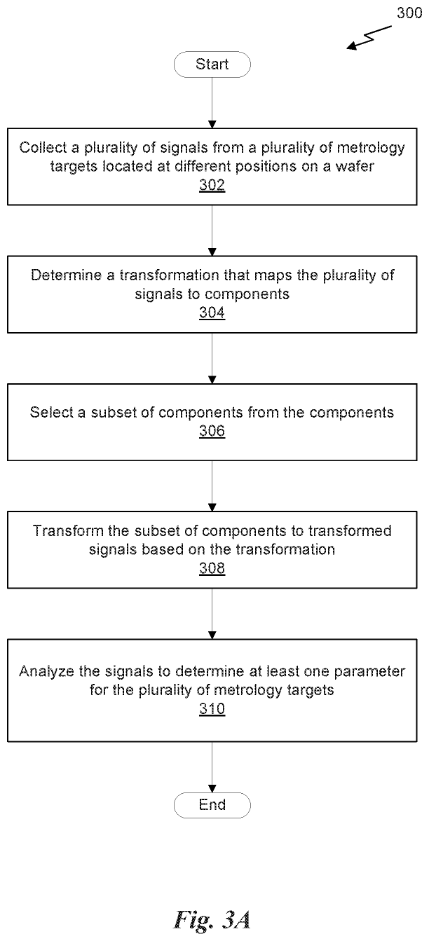

FIG. 2 illustrates a method for collecting a measurement of a metrology target, in accordance with one embodiment;

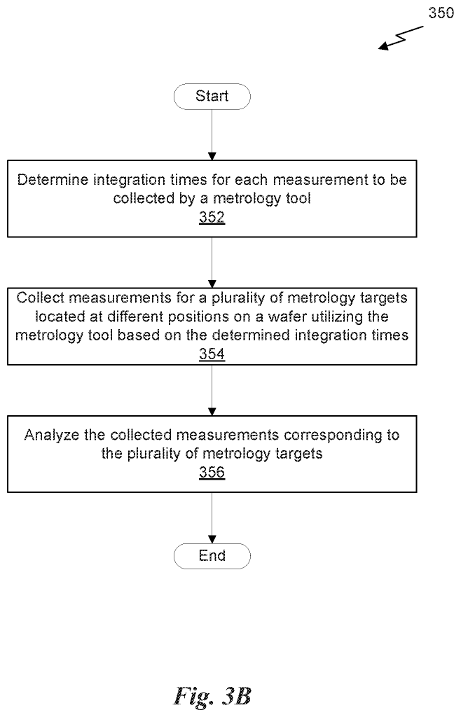

FIG. 3A illustrates a method for increasing precision of a measurement by collecting signals from multiple metrology targets, in accordance with an embodiment;

FIG. 3B illustrates a method for increasing precision of a measurement by collecting signals from multiple metrology targets, in accordance with an embodiment;

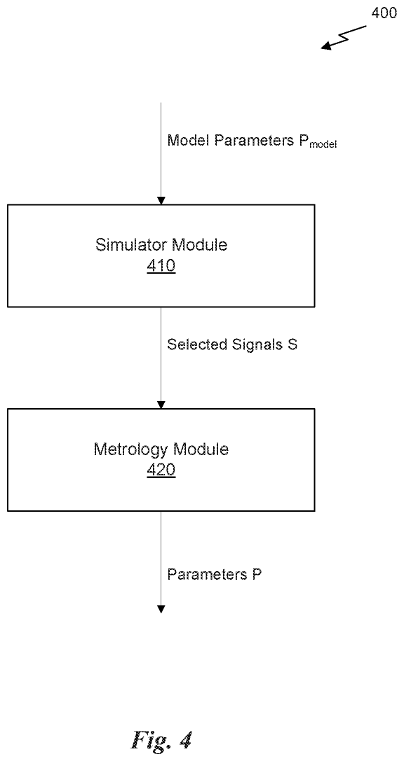

FIG. 4 is a conceptual illustration of a system 400 for measuring a metrology target, in accordance with one embodiment; and

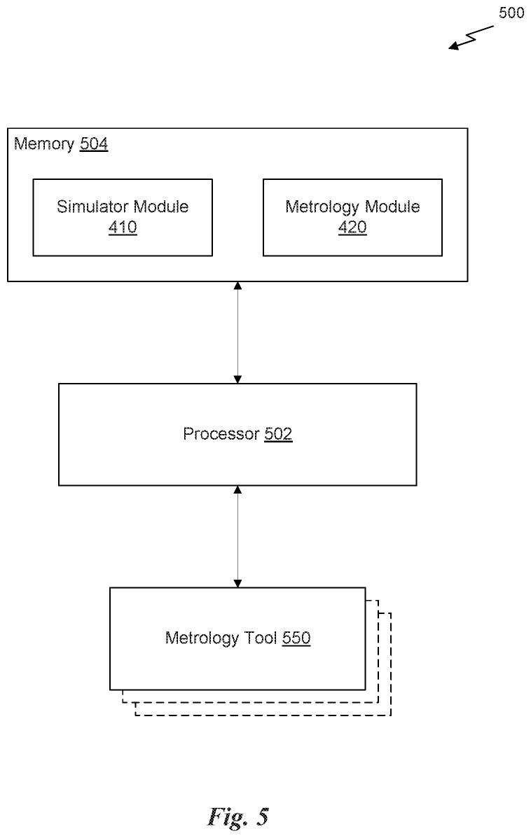

FIG. 5 illustrates an exemplary system in which the various architecture and/or functionality of the various previous embodiments may be implemented.

### DETAILED DESCRIPTION

In the field of semiconductor metrology, a metrology tool may comprise an illumination system which illuminates a target, a collection system which captures relevant information provided by the illumination system's interaction (or lack thereof) with a target, device or feature, and a processing system which analyzes the information collected using one or more algorithms. Metrology tools can be used to measure structural and material characteristics (e.g. material composition, dimensional characteristics of structures and films such as film thickness and/or critical dimensions of structures, overlay, etc.) associated with various semiconductor fabrication processes. These measurements are used to facilitate process controls and/or yield efficiencies in the manufacture of semiconductor dies.

The metrology tool can comprise one or more hardware configurations which may be used in conjunction with certain embodiments of this invention to, e.g., measure the various aforementioned semiconductor structural and material characteristics. Examples of such hardware configurations include, but are not limited to, the following:

Spectroscopic ellipsometer (SE);

SE with multiple angles of illumination;

SE measuring Mueller matrix elements (e.g. using rotating compensator(s));

Single-wavelength ellipsometers;

Beam profile ellipsometer (angle-resolved ellipsometer);

Beam profile reflectometer (angle-resolved reflectometer

Broadband reflective spectrometer (spectroscopic reflectometer);

Single-wavelength reflectometer;

Angle-resolved reflectometer;

Imaging system;

Scatterometer (e.g. speckle analyzer),

Small-angle X-ray scattering (SAXS) device;

X-ray powder diffraction (XRD) device;

X-ray Fluorescence (XRF) device;

X-ray photoelectron spectroscopy (XPS) device;

X-ray reflectivity (XRR) device;

Raman spectroscopy device;

scanning electron microscopy (SEM) device;

tunneling electron microscopy (TEM) device; and

atomic force microscope (AFM) device.

The hardware configurations can be separated into discrete operational systems. On the other hand, one or more hardware configurations can be combined into a single tool. One example of such a combination of multiple hardware configurations into a single tool is shown in FIG. 1, incorporated herein from U.S. Pat. No. 7,933,026 which is hereby incorporated by reference in its entirety for all purposes. FIG. 1 shows, for example, a schematic of an exemplary metrology tool that comprises: a) a broadband SE (i.e., 18); b) a SE (i.e., 2) with rotating compensator 98); c) a beam profile ellipsometer (i.e., 10); d) a beam profile reflectometer 12); e) a broadband reflective spectrometer (i.e., 14); and f) a deep ultra-violet reflective spectrometer (i.e., 16). In addition, there are typically numerous optical elements in such systems, including certain lenses, collimators, mirrors, quarter-wave plates, polarizers, detectors, cameras, apertures, and/or light sources. The wavelengths for optical systems can vary from about 120 nm to 3 microns. For non-ellipsometer systems, signals collected can be polarization-resolved or unpolarized. FIG. 1 provides an illustration of multiple metrology heads integrated on the same tool. However, in many cases, multiple metrology tools are used for measurements on a single or multiple metrology targets. This is described, for example, in U.S. Pat. No. 7,478,019, “Multiple tool and structure analysis,” which is also hereby incorporated by reference in its entirety for all purposes.

The illumination system of the certain hardware configurations includes one or more light sources. The light source may generate light having only one wavelength (i.e., monochromatic light), light having a number of discrete wavelengths (i.e., polychromatic light), light having multiple wavelengths (i.e., broadband light) and/or light that sweeps through wavelengths, either continuously or hopping between wavelengths (i.e. tunable sources or swept source). Examples of suitable light sources are: a white light source, an ultraviolet (UV) laser, an arc lamp or an electrode-less lamp, a laser sustained plasma (LSP) source, for example those commercially available from Energetiq Technology, Inc., Woburn, Mass., a super-continuum source (such as a broadband laser source) such as those commercially available from MKT Photonics Inc., Morganville, N.J., or shorter-wavelength sources such as x-ray sources, extreme UV sources, or some combination thereof. The light source may also be configured to provide light having sufficient brightness, which in some cases may be a brightness greater than about 1 W/(nm cm² Sr). The metrology system may also include a fast feedback to the light source for stabilizing its power and wavelength. Output of the light source can be delivered via free-space propagation, or in some cases delivered via optical fiber or light guide of any type.

The metrology tool is designed to make many different types of measurements related to semiconductor manufacturing. Certain embodiments may be applicable to such measurements. For example, in certain embodiments the tool may measure characteristics of one or more targets, such as critical dimensions, overlay, sidewall angles, film thicknesses, process-related parameters (e.g., focus and/or dose). The targets can include certain regions of interest that are periodic in nature, such as for example gratings in a memory die. Targets can include multiple layers (or films) whose thicknesses can be measured by the metrology tool. Targets can include target designs placed (or already existing) on the semiconductor wafer for use, e.g., with alignment and/or overlay registration operations. Certain targets can be located at various places on the semiconductor wafer. For example, targets can be located within the scribe lines (e.g., between dies) and/or located in the die itself. In certain embodiments, multiple targets are measured (at the same time or at differing times) by the same or multiple metrology tools as described in U.S. Pat. No. 7,478,019. The data from such measurements may be combined. Data from the metrology tool is used in the semiconductor manufacturing process for example to feed-forward, feed-backward and/or feed-sideways corrections to the process (e.g. lithography, etch) and therefore, might yield a complete process control solution.

As semiconductor device pattern dimensions continue to shrink, smaller metrology targets are often required. Furthermore, the measurement accuracy and matching to actual device characteristics increase the need for device-like targets as well as in-die and even on-device measurements. Various metrology implementations have been proposed to achieve that goal. For example, focused beam ellipsometry based on primarily reflective optics is one of them and described in the patent by Piwonka-Corle et al. (U.S. Pat. No. 5,608,526, “Focused beam spectroscopic ellipsometry method and system”) Apodizers can be used to mitigate the effects of optical diffraction causing the spread of the illumination spot beyond the size defined by geometric optics. The use of apodizers is described in the patent by Norton, U.S. Pat. No. 5,859,424, “Apodizing filter system useful for reducing spot size in optical measurements and other applications”. The use of high-numerical-aperture tools with simultaneous multiple angle-of-incidence illumination is another way to achieve small-target capability. This technique is described, e.g. in the patent by Opsal et al, U.S. Pat. No. 6,429,943, “Critical dimension analysis with simultaneous multiple angle of incidence measurements”.

Other measurement examples may include measuring the composition of one or more layers of the semiconductor stack, measuring certain defects on (or within) the wafer, and measuring the amount of photolithographic radiation exposed to the wafer. In some cases, the metrology tool and algorithm may be configured for measuring non-periodic targets, see e.g. “The Finite Element Method for Full Wave Electromagnetic Simulations in CD Metrology Using Scatterometry” by P. Jiang et al (pending U.S. patent application Ser. No. 14/294,540, filed Jun. 3, 2014) or “Method of electromagnetic modeling of finite structures and finite illumination for metrology and inspection” by A. Kuznetsov et al. (pending U.S. patent application Ser. No. 14/170,150).

Measurement of parameters of interest usually involves a number of algorithms. For example, optical interaction of the incident beam with the sample is modeled using EM (electro-magnetic) solver and uses such algorithms as RCWA, FEM, method of moments, surface integral method, volume integral method, FDTD, and others. The target of interest is usually modeled (parameterized) using a geometric engine, or in some cases, a process modeling engine or a combination of both. The use of process modeling is described in “Method for integrated use of model-based metrology and a process model,” by A. Kuznetsov et al. (pending U.S. patent application Ser. No. 14/107,850). A geometric engine is implemented, for example, in AcuShape software product of KLA-Tencor.

Collected data can be analyzed by a number of data fitting and optimization techniques and technologies including libraries; Fast-reduced-order models; regression; machine-learning algorithms such as neural networks and support-vector machines (SVM); dimensionality-reduction algorithms such as, e.g., PCA (principal component analysis), ICA (independent component analysis), LLE (local-linear embedding); sparse representation such as Fourier or wavelet transform; Kalman filter; algorithms to promote matching from same or different tool types, and others.

Collected data can also be analyzed by algorithms that do not include modeling, optimization and/or fitting e.g. U.S. patent application Ser. No. 14/057,827.

Computational algorithms are usually optimized for metrology applications with one or more approaches being used such as design and implementation of computational hardware, parallelization, distribution of computation, load-balancing, multi-service support, dynamic load optimization, etc. Different implementations of algorithms can be done in firmware, software, FPGA, programmable optics components, etc.

The data analysis and fitting steps usually pursue one or more of the following goals:

Measurement of CD, SWA, shape, stress, composition, films, band-gap, electrical properties, focus/dose, overlay, generating process parameters (e.g., resist state, partial pressure, temperature, focusing model), and/or any combination thereof;

Modeling and/or design of metrology systems; and

Modeling, design, and/or optimization of metrology targets.

The following description discloses embodiments of a method, a system (having a processor for performing the method), and a computer program product (embodied on a non-transitory computer readable medium and having code adapted to be executed by a computer to perform the method) for measuring a metrology target utilizing a metrology tool.

The metrology tool may be any of those tools described above with reference to FIG. 1 or may be other type of metrology tools. A plurality of metrology tools may reside on a single hardware platform or different hardware platforms. When on a single hardware platform, a processor of a computer system residing on the same or different hardware platform is in communication with the metrology tool(s) to perform the methods described with respect to the subsequent figures below. When on different hardware platforms, the processor of the computer may reside on one of the hardware platforms having one of the metrology tools or may reside on an entirely different platform, but again, is in communication with the metrology tool(s) to perform the methods described with respect to the subsequent figures below.

The techniques described below optimize the efficiency of electromagnetic simulations and the acquisition time of metrology systems by selecting the signals and metrology tools and configurations that provide the best performance for collecting a measurement of one or more parameters of a metrology target. These techniques may be applied to optical systems using wavelengths within the visible light spectrum (e.g., ˜400 nm to 700 nm), but the techniques may also be extended into a broader range of wavelengths such as x-rays, extreme ultraviolet, and far infrared, as well as others.

As used herein, performance may refer to a precision of a resulting measurement. The precision may be calculated by taking an error between simulated signals and signals collected with the system defined by the selected subset of signals. The precision may be defined by comparing the system with a single “ideal” system (tool-to-tool) or by comparing the system with the average measurement from a plurality of different systems (tool-to-fleet). The precision may also refer to the robustness and/or accuracy of the resulting measurement system due to known systematic errors or any combination of these metrics for any or all measured parameters.

In the presence of small changes in measured parameters (ΔP), the mapping from measured signals (Sₘ) to parameters can be described by a Taylor series around the correct signal (S₀) to a sufficient degree, as shown in Equation 1:

Sₘ≅S₀+JΔP (Eq. 1)

The likely errors of the measurement are the differences between the correct signal (S₀) and the simulated measured signal (Sₘ). The likely errors include errors due to noise with a known covariance matrix (S_{cov}) system noise, fleet matching variance, etc.) and errors with offsets such as fixed parameters, system tolerances, and the like. In any case, the best performance in the presence of a known covariance matrix is the well-known best linear un-biased estimator (BLUE), as shown in Equation 2:

Sₘ≅S₀+JΔP

S_{cov}^{-1/2}JΔP=S_{cov}^{-1/2}(Sₘ−S₀)

(S_{cov}^{-1/2}J)^{T}S_{cov}^{-1/2}JΔP=(S_{cov}^{-1/2}J)^{T}S_{cov}^{-1/2}(Sₘ−S₀)

ΔP=(J^{T}S_{cov}⁻¹J)J^{T}S_{cov}⁻¹(Sₘ−S₀) (Eq. 2)

In Equation 2, the term S_{cov}^{-1/2}J is often referred to as the normalized Jacobian matrix (H) as the term both de-correlates (“whitens”) the noise described by the covariance matrix and ensures that the noise variance of each signal is unity. This provides the best precision with no degradation of the average measured parameters, hence the term best linear un-biased estimator. However, the best performance may require that all signals (i.e., the signals associated with all rows of the normalized Jacobian matrix) be utilized to take the measurement, which is not feasible for the throughput sensitive semiconductor industry. Optimization of the selection of signals is possible by analyzing the improvement to precision when the number of signals selected is only a subset of all possible signals.

FIG. 2 illustrates a method 200 for collecting a measurement of a metrology target, in accordance with one embodiment. At step 202, a set of signals for measuring one or more parameters of a metrology target is simulated. The set of signals S may refer to a spectra measured by the metrology tool T. The particular format of the signals S depends on the type of metrology tool being calibrated. For example, a signal may refer to an intensity of light measured by a detector as a beam of light is focused on a location L associated with a metrology target. Each signal in the set of signals may refer to a measurement taken at a. different location L, or using a different wavelength of light, or with a different configuration or orientation of the metrology tool.

In one embodiment, a simulator module is implemented that comprises instructions that generate a set of signals based on a model of a system including the metrology tool and one or more metrology targets on a wafer defined by a set of modeling parameters. The modeling parameters may be geometric parameters (e.g., critical dimension, sidewall angle, profile height, etc.), material composition parameters, process parameters (e.g., focus parameter, dose parameter, etc.), an overlay parameter, and/or any other parameters. The simulator module may be configured to generate a set of simulated signals that emulate signals generated by one or more metrology tools based on the modeling parameters that define a model of the metrology system.

In particular, the simulated set of signals may take the form of raw data collected by the metrology tool(s) for measuring one or more parameters of the metrology target. Table 1 illustrates various examples of raw data collected by different metrology tools. The examples of Table 1 are not to be construed as limiting in any way as other types of raw data from different tools may be emulated by the simulated signals and is within the scope of the present disclosure.

TABLE 1
(1) diffracted intensity vs. diffraction angle from a HRXRD
tool
(2) fluorescent intensity vs. photon energy from a x-ray
fluorescence (XRF) tool
(3) Raman scattering intensity vs. wavenumber from a
Raman scattering tool
(4) x-ray photoelectron counts vs. binding energy for a x-
ray photoelectron spectroscopy (XPS) tool
(5) ellipsometer or reflectometer signal vs. wavelength for
a spectroscopic scatterometer (OCD) tool
(6) x-ray reflectance vs. angle of incidence for a x-ray
reflectometer (XRR)
(7) reflectance vs. incidence angle for an angle-based
scatterometry tool
(8) diffracted intensity vs. angle for a small angle x-ray
scattering (SAXS) tool

At step 204, a Jacobian matrix is generated based on the set of simulated signals. A Jacobian matrix encodes the partial derivatives of each signal in the set of signals with respect to each of the one or more parameters. In one embodiment, the simulator module modulates the parameters during the simulation to determine how a change in a particular parameter affects each signal and generates the Jacobian matrix by calculating the difference in the simulated signal values normalized by the change in the parameters. In another embodiment, the Jacobian matrix may be generated by varying parameter values for each parameter to generate a plurality of values for each signal based on the various combinations of input parameters. The simulated signal values are then fit to a curve (e.g., a second order polynomial). A derivative of the curve may then be evaluated for different input parameters to derive an estimate for the partial derivatives in the Jacobian matrix. Essentially, the coefficients of the curve may be utilized to evaluate the partial derivatives of each of the signals. Other methods for generating the Jacobian matrix may be implemented, such as fitting the simulated signal values to higher order polynomials, and are within the scope of the present disclosure.

At step 206, a normalized Jacobian matrix is generated based on the Jacobian matrix and a covariance matrix. The normalized Jacobian matrix may be calculated by finding the covariance matrix of the set of simulated signals (S,) and multiplying the Jacobian matrix by the inverse of a square root of the covariance matrix of the set of simulated signals; i.e., H=S_{cov}^{-1/2}J. It will be appreciated that the square root operator here is defined as a matrix M, such that M^{T}M=S_{cov}

At step 208, a subset of signals from the simulated set of signals is selected based on the normalized Jacobian matrix. In one embodiment, the structure of the normalized Jacobian matrix (H) is utilized to generate an initial subset of signals that optimizes a performance metric associated with measuring the one or more parameters of the metrology target. The performance metric may be based on a precision of the measurement of each parameter. Given that the covariance of the normalized Jacobian matrix is the identity matrix, the covariance of the measured parameters can be calculated efficiently as given in Equation 3:

P_{cov}=(H^{T}H)⁻¹ (Eq. 3)

Using singular value decomposition, a set of orthogonal bases to diagonalize H may be found, as shown in Equation 4:

H=UΣV^{T} (Eq. 4)

The covariance matrix of the parameters may then be written as:

P_{cov}=(VΣ²V^{T})⁻¹=V^{T}Σ⁻²V (Eq. 5)

The eigenvalues (Λ) and corresponding eigenvectors (M) of the covariance matrix of the parameters are:

Λ=Σ⁻², V=M (Eq. 6)

As an approximation, the rows of the normalized Jacobian matrix (H) that have the largest normed projection on the large eigenvectors associated with the largest eigenvalues in Λ, and therefore the smallest values of Σ, provide the most benefit to the structure of the normalized Jacobian matrix H. The normed projection is simply the inner product of the rows of H and eigenvectors of the covariance matrix P_{cov}. In other words, the signals corresponding to the rows of the normalized Jacobian matrix H that have the largest projection on the dominant eigenvectors of Λ, may be selected as the subset of signals that optimize the measurement of the parameters utilizing the metrology tool. This technique ensures that the initial selection of the subset of signals includes high sensitivity and supports the rank of the normalized Jacobian matrix H.

In one embodiment, weights may be added to the selection process. For example, each row of the normalized Jacobian matrix H may he projected onto the dominant eigenvectors of Λ and then scaled by an appropriate weight. Then, the weighted projection values are compared in order to select the subset of signals. The weights may take into account acquisition or simulation time and the importance of particular measured parameters. For example, some signals may take longer to setup and collect than other signals. The weights may reflect that signals that are easier to collect have higher priority than signals that are harder to collect since more of the easier to collect signals may be able to be collected in a particular time frame. In another example, the importance of one parameter to the manufactured device may be taken into account by weights that reflect that signals that affect the precision of one parameter over another are given precedence. In general, the weight for a given signal is set according to criteria including at least one of a choice of the metrology tool, a wavelength, an incidence angle, an azimuth angle, a polarization, a focal length, an integration time, and/or other parameters associated with the measurements.

The above technique selects the subset of signals based on precision (i.e., by minimizing the error expected based on the covariance matrix of the parameters). In one embodiment, a formula that defines a performance metric (PM) may be specified that is calculated for each signal in the set of signals S. For example, the performance metric described above is given as:

PM₁= [symbol] P_{cov}, M [symbol] (Eq. 7)

Equation 7 is calculated per signal and gives the inner product of the row in the covariance matrix corresponding to the signal with the eigenvector M.

Additional performance metrics may also be calculated, such as a performance metric based on differences in accuracy of the selected metrology tool used to generate the signal. Manufacturing tolerances and calibration accuracy of a particular tool can affect the accuracy of the measurement of a given signal. Divergence of a particular tool from the nominal dimensions may affect the accuracy of the measured signal. Since tolerances associated with these dimensions may affect some signals more than others, models can be built to estimate the accuracy of a signal based on tool-to-tool selection differences. In other words, the performance metric may differentiate signals based on how the signal's variance is affected by tool to tool matching. The performance metric may be given as:

PM₂=(J^{T}J)⁻¹J^{T}ΔSignal_{Tool}(J^{T}J)⁻¹J^{T})^{T} (Eq. 8)

Again, Equation 8 is calculated per signal and quantifies variance of the signal as affected by tool to tool matching variance. In this embodiment, the term ΔSignal_{Tool} is the covariance of signals across tools. This vector can be generated experimentally by recording the variance of signals across a fleet of tools for the same wafer. This variance can also be computed by using known sources of mismatch across tools.

Yet another performance metric may be calculated, such as a performance metric based on the robustness of each signal. Model-based metrology requires a physical model to map signals to metrology values. There are many uncertainties in the model that can degrade performance. For example, the dispersion of the materials, the number of Fourier modes required to match the observed signals, missing interfacial layers between structures, or the non-periodicity of the target. The effect of these errors can be simulated by perturbations to the model, which cause perturbations of the signal, ΔSignalₑᵣᵣₒᵣ. The resulting selection of signals has the lowest projection of assumed errors onto measured signals. In other words, the performance metric may differentiate signals based on how the signal's variance is affected by various sources of error. The performance metric may be given as:

PM₃=(J^{T}J)⁻¹J^{T}ΔSignalₑᵣᵣₒᵣ((J^{T}J)⁻¹J^{T})^{T} (Eq. 9)

Again, Equation 9 is calculated per signal and quantifies variance of the signal as affected by estimated sources of error. The term ΔSignalₑᵣᵣₒᵣ is a vector that quantifies how a signal is affected by various sources of error.

Although any of the performance metrics may be utilized to select the subset of signals, it will be appreciated that multiple performance metrics may be combined in order to generate a unified performance metric, as follows:

PM=\sqrt{αPM₁²+βPM₂²+γPM₃²} (Eq. 10)

As shown in Equation 10, the unified performance metric combines multiple independent performance metrics for each signal using weight coefficients (α, β, and γ). In one embodiment, each of the weight coefficients may be set between 0 and 1.

At step 210, the subset of selected signals may be adjusted. In some embodiments, step 210 may be omitted, and the subset of signals selected in step 208 is utilized to take the measurements of the metrology target. Adjusting the initial subset of signals selected based on the normalized Jacobian matrix in step 208 may be referred to as annealing the subset of signals. Annealing may consist of growing or shrinking the number of signals in the subset of signals.

In one embodiment, the subset of signals may be grown by adding the next signal in all signals not included in the subset of signals that has the greatest effect on increasing the precision of the measurement. For example, the projected values associated with rows of the normalized Jacobian matrix H are compared to find a. maximum projected value and, then, the signal associated with that row of the normalized Jacobian matrix H is added to the subset of signals. Additional signals may be added to the subset until a calculated performance level of the subset of selected signals is above some threshold value.

In another embodiment, the subset of signals may be shrunk by removing the signal in the subset of signals that has the least effect on increasing the precision of the measurement. For example, the projected values associated with rows of the normalized Jacobian matrix H associated with signals in the subset of signals are compared to find a minimum projected value and, then, the signal associated with that row of the normalized Jacobian matrix H is removed from the subset of signals. Additional signals may be removed from the subset until a calculated performance level of the subset of selected signals is below some threshold value. By removing signals from the subset of signals, the measurement time to measure a parameter may be decreased, which increases throughput of the manufacturing process, while ensuring that a precision of the measurement stays within some acceptable boundary.

In yet another embodiment, the subset of signals may be grown and shrunk by removing some signals from the subset of signals and adding other signals to the subset of signals. The annealing step may be repeated a number of times, either growing or shrinking the subset of signals at each step until either: (1) a performance associated with the subset of signals surpasses a threshold level of performance; (2) the annealing step reaches convergence where the same signal is removed and/or added to the subset in two adjacent steps; or (3) some timeout period is reached.

As shown in FIG. 2, the precision of a measurement may be increased by optimally selecting a subset of signals to collect using one or more metrology tools. The precision for a subset of signals selected via this technique will be better than utilizing the same number of signals being uniformly divided within a particular wavelength range, for example. Reducing the number of signals collected for a measurement increases throughput while ensuring an optimal performance with regard to the reduced set of collected signals.

Another technique for increasing the precision of a measurement is to take multiple measurements of the same target. For example, collecting a plurality of samples of the same signal may result in a number of values distributed within a particular range. The reason for the various different values may be due to various sources of error such as noise, accuracy of the tool, etc. However, as the number of samples increases, the distribution of the values will tend to center on the real value for the measurement. For example, with random noise, the distribution of sampled values may form a normal distribution around a mean centered on the real value. While the error of any one particular measurement may be large, an error associated with the mean of the large number of sampled values may be much smaller.

Of course, increasing the number of samples for measuring a particular metrology target means increasing the time required to collect the measurement. This is not ideal, especially in cases like X-Ray metrology tools where longer integration time of a single measurement can translate into better precision by itself. However, many silicon wafers include multiple similar metrology targets having approximately the same structures. Because the metrology targets are designed to be identical, only slight variances in the structures may be realized during fabrication. Furthermore, the variances may correlate well with location on the wafer. For example, variations in a critical dimension parameter may be greatest at locations on the wafer closer to the edge of the wafer than the center of the wafer. These relationships can be exploited to increase the precision of a measurement applied to a plurality of metrology targets simultaneously.

FIG. 3A illustrates a method 300 for increasing precision of a measurement by collecting signals from multiple metrology targets, in accordance with an embodiment. At step 302, a plurality of signals S are collected from a plurality of metrology targets located at different positions on a wafer. The metrology targets should be similar structures that, ideally, have the same parameters (i.e., critical dimensions, composition, etc.). There may be minor differences in the metrology targets due to differences in fabrication conditions at the different locations, but, theoretically, the signals S should be attempting to take the same measurement of similar but different structures.

The subset of signals selected in method 200 may be used to collect measurements from each metrology target. In other words, the technique shown above in reference to FIG. 2 may be used to determine which signals to collect for a particular metrology target in the plurality of metrology targets, and then measurements for the subset of signals are collected at each metrology target in the plurality of metrology targets to collect the plurality of signals S from the plurality of metrology targets.

At step 304, a transformation T is determined that maps the plurality of signals to components C. The transformation T may be determined based on the set of signals S. In one embodiment, the set of signals S are analyzed using principal component analysis (PCA) to determine the principal components of the set of signals S. The principal components are then utilized to fit a transformation T to the set of signals S that results in a close fit to the principal components. In other embodiments, techniques other than PCA may be utilized to find the transformation T based on the set of signals S, such as ICA, kernel PCA, or trained auto-encoders.

At step 306, a subset of components C₁ is selected from the components C. In one embodiment, the subset of components C₁ is selected based on a signal-to-noise ratio (SNR) where all components in the set of components C having a SNR above a threshold level are selected as within the subset of components C₁. In another embodiment, the subset of components C₁ is selected based on an analysis of the information content in the components C. For example, an algorithm may determine whether the values of each type of component are within an expected range.

It will be appreciated that step 306 essentially removes noise from the collected spectra. Only principal components of the spectra above a noise threshold are kept for use in the analysis. This increases the precision of the measurement even when the collected set of signals includes a lot of noise.

At step 308, the subset of components C₁ is transformed into transformed signals S₁ based on the transformation T. The transformation T is linear, so the subset of components C₁ may be transformed back into corresponding signals S₁. It will be appreciated that the corresponding signals S₁ may be different from the collected set of signals S due to the removal of some components from the set of components C.

At step 310, the signals S₁ are analyzed to determine at least one parameter for the plurality of metrology targets on the wafer. Determining the one or more parameters for a particular metrology target includes analysis of measurements associated with at least one other metrology target. In other words, signals associated with the group of metrology targets are analyzed as a whole rather than only analyzing the signals associated with an isolated metrology target to determine parameters for that particular metrology target.

In conventional analytical systems utilized in wafer metrology, all signals associated with a single metrology target may be analyzed to determine a particular parameter for the metrology target. In contrast, at step 310, the signals S₁ include similar signals (i.e., the same tool, the same tool configuration, the same wavelength, etc.) for different metrology targets taken at different locations of the wafer. By analyzing signals for multiple metrology targets at the same time, increased precision in the measurement may be achieved.

In an alternative embodiment, the subset of component C₁ is utilized directly to determine the parameters of the metrology targets and step 308 is omitted. In such embodiments, step 310 analyzes the subset of components G, rather than the signals S₁.

FIG. 3B illustrates a method 350 for increasing precision of a measurement by collecting signals from multiple metrology targets, in accordance with another embodiment. At step 352, integration times are determined for each measurement to be collected using a metrology tool. The integration times may refer to a time period for which a signal is collected by the metrology tool. The integration times may be determined to meet a first level of precision. For example, when using a x-ray metrology tool (e.g., SAXS, XRD, XRF, XI′S, etc.) the precision of a particular measurement may be limited by photon shot noise, where the precision is given by equation 8:

$${σ}^{\sim 1} / {\sqrt{{N}_{photons}}}^{\sim 1 / \sqrt{t}} \qquad ( Eq . 8 )$$

Equation 8 shows that the standard deviation of a measurement goes down (i.e., precision increases) when measurement time increases. The actual relationship between a measurement time and a particular level of precision may be determined analytically and selected based on a required level of precision for a particular measurement.

At step 354, measurements of a plurality of metrology targets located at different positions on a wafer are collected utilizing the metrology tool based on the determined integration times. Each distinct measurement collected for a particular integration time may be taken once per metrology target in the plurality of metrology targets, and multiple measurements using one or more metrology tools and different integration times may be collected for each metrology target.

At step 356, the collected measurements corresponding to the plurality of metrology targets are analyzed to reduce statistical variations of each measurement. Again, by analyzing the measurements as a whole, rather than individually, the precision of a particular measurement can be increased above the first level of precision.

In one embodiment, an overlay map is generated based on the collected measurements. The overlap map may represent a set of reference measurements that may be utilized to calibrate high-throughput metrology tools that measure the same metrology targets on a plurality of similar wafers. The overlay map from one wafer may be utilized during the analysis of collected measurements from a different wafer in order to increase the precision of the measured parameters.

FIG. 4 is a conceptual illustration of a system 400 for measuring a metrology target, in accordance with one embodiment. As shown in FIG. 4, the system 400 includes a simulator module 410 and a metrology module 420. The simulator module 410 receives the modeling parameters P_{model} and simulates a set of signals S′, calculates a Jacobian matrix, normalizes the Jacobian matrix based on a covariance matrix, and selects a subset of signals S from the set of simulated signals S′ that optimizes a performance metric associated with the measurement. The metrology module 420 receives the subset of selected signals S and generates the structural parameters P measured for one or more metrology targets on a wafer. The metrology tool may be configured by the metrology module 420 in order to collect each measurement specified in the subset of selected signals S.

It will be appreciated that the system 400 may be repeated for each of multiple metrology tools. For example, each metrology tool shown in FIG. 1 may be associated with a separate and distinct simulator module 410 and corresponding metrology module 420. These modules may be operated in parallel in order to collect measurements for the specified signals S for each of the multiple metrology tools.

FIG. 5 illustrates an exemplary system in which the various architecture and/or functionality of the various previous embodiments may be implemented. As shown, a system 500 is provided including at least a processor 502 and a memory 504 associated with one or more metrology tools 550. The memory 504 may include both volatile and non-volatile memory for storing program instructions and/or data. In one embodiment, the memory 504 includes a hard disk drive (HDD) storing the simulator module 410 and the metrology module 420 and SDRAM, on which an operating system, application(s), simulator module 410, and metrology module 420 may be loaded during execution.

One embodiment relates to a non-transitory computer-readable medium storing program instructions executable on a computer system for performing a computer-implemented method, such as the methods discussed herein. Program instructions implementing methods, such as those described herein, may be stored on a computer-readable medium, such as memory 504. The computer-readable medium may be a storage medium such as a magnetic or optical disk, or a magnetic tape or any other suitable non-transitory computer-readable medium known in the art. As an option, the computer-readable medium may be located within system 500. Alternatively, the computer-readable medium may be external to system 500, where system 500 is configured to load the program instructions from the computer readable medium into memory 504.

The program instructions may be implemented in any of various ways, including procedure-based techniques, component-based techniques, and/or object-oriented techniques, among others. For example, the program instructions may be implemented using ActiveX controls, C++ objects, JavaBeans, Microsoft Foundation Classes (“WC”), or other technologies or methodologies, as desired.

The system 500 may take various forms, including a personal computer system, image computer, mainframe computer system, workstation, network appliance, Internet appliance, or other device. In general, the term “computer system” may be broadly defined to encompass any device having one or more processors, which executes instructions from a memory medium. The system 500 may also include any suitable processor known in the art such as a parallel processor. In addition, the system 500 may include a computer platform with high speed processing and software, either as a standalone or a networked tool.

While various embodiments have been described above, it should be understood that they have been presented by way of example only, and not limitation. Thus, the breadth and scope of a preferred embodiment should not be limited by any of the above-described exemplary embodiments, but should be defined only in accordance with the following claims and their equivalents.

1. A method, comprising:
simulating, via a processor executing a simulator module, a set of signals for measuring one or more parameters of a metrology target, each signal in the set of signals having one or more configurations for measuring the one or more parameters of the metrology target;
generating a normalized Jacobian matrix corresponding to the set of signals;
selecting a subset of signals in the simulated set of signals that optimizes a performance metric associated with measuring the one or more parameters of the metrology target, based on the normalized Jacobian matrix, wherein the subset of signals includes fewer signals than the set of signals; and
utilizing a metrology tool to collect a measurement for the one or more parameters of the metrology target using the selected subset of signals, wherein the metrology tool includes one of:
a spectroscopic ellipsometer (SE);
a SE with multiple angles of illumination;
a SE measuring Mueller matrix elements;
a single-wavelength ellipsometers;
a beam profile ellipsometer;
a beam profile reflectometer;
a broadband reflective spectrometer;
a single-wavelength reflectometer;
an angle-resolved reflectometer;
an imaging system;
a scatterometer;
a small-angle x-ray scattering (SAXS) device;
an x-ray powder diffraction (XRD) device;
an x-ray Fluorescence (XRF) device;
an x-ray photoelectron spectroscopy (XPS) device;
an x-ray reflectivity (XRR) device;
a Raman spectroscopy device;
a scanning electron microscopy (SEM) device;
a tunneling electron microscope (TEM) device; and
an atomic force microscope (AFM) device.

2. The method of claim 1, wherein selecting the subset of signals comprises:
generating a covariance matrix for the one or more parameters of the metrology target;
calculating a normed projection value for each row of the normalized Jacobian matrix by projecting the row onto one or more eigenvectors of the covariance matrix; and
selecting, as the subset of signals, a number of signals in the simulated set of signals corresponding with the rows of the normalized Jacobian matrix having the largest normed projection values.

3. The method of claim 2, wherein calculating the normed projection value for each row comprises multiplying by a weight.

4. The method of claim 3, wherein the weight is set according to criteria including at least one of a choice of the metrology tool, a wavelength, an incidence angle, an azimuth angle, a polarization, a focal length, an integration time, or other parameters associated with the measurements.

5. The method of claim 1, wherein the one or more parameters include at least one of a critical dimension of the metrology target and a material characteristic.

6. The method of claim 1, wherein the performance metric is based on a precision of the measurement of each parameter.

7. The method of claim 1, wherein the performance metric is a unified performance metric that combines multiple performance metrics utilizing weight coefficients.

8. The method of claim 1, wherein the simulator module comprises instructions that generate the set of signals based on a model of a system including the metrology tool and one or more metrology targets on a wafer defined by a set of modeling parameters.

9. (canceled)

10. The method of claim 1, further comprising:
utilizing the metrology tool to collect a measurement for the one or more parameters of one or more additional metrology targets using the selected subset of signals; and
analyzing the measurements collected for the metrology target and the one or more additional metrology targets to determine the one or more parameters for each of the metrology targets,
wherein determining the one or more parameters for a particular metrology target includes analysis of measurements associated with at least one other metrology target.

11. The method of claim 10, wherein the measurement collected for the metrology target and the one or more additional metrology targets are utilized as a reference set of signals to calibrate high-throughput metrology tools.

12. The method of claim 10, wherein the metrology tool is an x-ray metrology tool.

13. A computer program product embodied on a non-transitory computer readable medium, the computer program product including code adapted to be executed by a computer to perform a method comprising:
simulating, via a processor executing a simulator module, a set of signals for measuring one or more parameters of a metrology target, each signal in the set of signals having one or more configurations for measuring the one or more parameters of the metrology target;
generating a normalized Jacobian matrix corresponding to the set of signals;
selecting a subset of signals in the simulated set of signals that optimizes a performance metric associated with measuring the one or more parameters of the metrology target, based on the normalized Jacobian matrix, wherein the subset of signals includes fewer signals than the set of signals; and
utilizing a metrology tool to collect a measurement for the one or more parameters of the metrology target using the selected subset of signals, wherein the metrology tool includes one of:
a spectroscopic ellipsometer (SE);
a SE with multiple angles of illumination;
a SE measuring Mueller matrix elements;
a single-wavelength ellipsometers;
a beam profile ellipsometer;
a beam profile reflectometer;
a broadband reflective spectrometer;
a single-wavelength reflectometer;
an angle-resolved reflectometer;
an imaging system;
a scatterometer;
a small-angle x-ray scattering (SAXS) device;
an x-ray powder diffraction (XRD) device;
an x-ray Fluorescence (XRF) device;
an x-ray photoelectron spectroscopy (XPS) device;
an x-ray reflectivity (XRR) device;
a Raman spectroscopy device;
a scanning electron microscopy (SEM) device;
a tunneling electron microscope (TEM) device; and
an atomic force microscope (AFM) device.

14. The computer program product of claim 13, wherein selecting the subset of signals comprises:
generating a covariance matrix for the one or more parameters of the metrology target;
calculating a normed projection value for each row of the normalized Jacobian matrix by projecting the row onto one or more eigenvectors of the covariance matrix; and
selecting, as the subset of signals, a number of signals in the simulated set of signals corresponding with the rows of the normalized Jacobian matrix having the largest normed projection values.

15. The computer program product of claim 13, wherein the simulator module comprises instructions that generate the set of signals based on a model of a system including the metrology tool and one or more metrology targets on a wafer defined by a set of modeling parameters.

16. The computer program product of claim 13, the method further comprising:
utilizing the metrology tool to collect a measurement for the one or more parameters of one or more additional metrology targets using the selected subset of signals; and
analyzing the measurements collected for the metrology target and the one or more additional metrology targets to determine the one or more parameters for each of the metrology targets,
wherein determining the one or more parameters for a particular metrology target includes analysis of measurements associated with at least one other metrology target.

17. A system, comprising:
a memory storing a simulator module;
a metrology tool for collecting measurements associated with metrology targets on a wafer; and
a processor coupled to the memory and configured to:
simulate, via the simulator module, a set of signals for measuring one or more parameters of a metrology target, each signal in the set of signals having one or more configurations for measuring the one or more parameters of the metrology target,
generate a normalized Jacobian matrix corresponding to the set of signals,
select a subset of signals in the simulated set of signals that optimizes a performance metric associated with measuring the one or more parameters of the metrology target, based on the normalized Jacobian matrix, wherein the subset of signals includes fewer signals than the set of signals, and
utilize the metrology tool to collect a measurement for the one or more parameters of the metrology target using the selected subset of signals, wherein the metrology tool includes one of:
a spectroscopic ellipsometer (SE);
a SE with multiple angles of illumination;
a SE measuring Mueller matrix elements;
a single-wavelength ellipsometers;
a beam profile ellipsometer;
a beam profile reflectometer;
a broadband reflective spectrometer;
a single-wavelength reflectometer;
an angle-resolved reflectometer;
an imaging system;
a scatterometer;
a small-angle x-ray scattering (SAXS) device;
an x-ray powder diffraction (XRD) device;
an x-ray Fluorescence (XRF) device;
an x-ray photoelectron spectroscopy (XPS) device;
an x-ray reflectivity (XRR) device;
a Raman spectroscopy device;
a scanning electron microscopy (SEM) device;
a tunneling electron microscope (TEM) device; and
an atomic force microscope (AFM) device.

18. The system of claim 17, wherein selecting the subset of signals comprises:
generating a covariance matrix for the one or more parameters of the metrology target;
calculating a normed projection value for each row of the normalized Jacobian matrix by projecting the row onto one or more eigenvectors of the covariance matrix; and
selecting, as the subset of signals, a number of signals in the simulated set of signals corresponding with the rows of the normalized Jacobian matrix having the largest normed projection values.

19. The system of claim 18, wherein calculating the normed projection value for each row comprises multiplying by a weight.

20. The system of claim 19, wherein the weight is set according to criteria including at least one of a choice of the metrology tool, a wavelength, an incidence angle, an azimuth angle, a polarization, a focal length, an integration time, or other parameters associated with the measurements.

21. The system of claim 17, wherein the one or more parameters include at least one of a critical dimension of the metrology target and a material characteristic.

22. The system of claim 17, wherein the performance metric is based on a precision of the measurement of each parameter.

23. The system of claim 17, wherein the performance metric is a unified performance metric that combines multiple performance metrics utilizing weight coefficients.

24. The system of claim 17, wherein the simulator module comprises instructions that generate the set of signals based on a model of a system including the metrology tool and one or more metrology targets on a wafer defined by a set of modeling parameters.

25. (canceled)

26. The system of claim 17, the processor further configured to:
utilize the metrology tool to collect a measurement for the one or more parameters of one or more additional metrology targets using the selected subset of signals; and
analyze the measurements collected for the metrology target and the one or more additional metrology targets to determine the one or more parameters for each of the metrology targets,
wherein determining the one or more parameters for a particular metrology target includes analysis of measurements associated with at least one other metrology target.

27. The system of claim 26, wherein the measurement collected for the metrology target and the one or more additional metrology targets are utilized as a reference set of signals to calibrate high-throughput metrology tools.

28. The system of claim 26, wherein the metrology tool is an x-ray metrology tool.
